(19) United States
(12) Patent Application Publication
(10) Pub. No.: US 2013/0048519 A1
(43) Pub. Date: Feb. 28, 2013

(54) HOUSING OF PORTABLE ELECTRONIC DEVICES AND METHOD FOR MANUFACTURING THE SAME

(71) Applicant: KAI-RONG LIAO, Shenzhen City (CN)

(72) Inventor: KAI-RONG LIAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/247,028

(22) Filed: Sep. 28, 2011

(30) Foreign Application Priority Data
Aug. 29, 2011 (CN) 201110250805.8

(51) Int. Cl. B65D 85/00; B29C 35/08

(52) U.S. Cl. 206/320; 264/400

(57) ABSTRACT

A housing of portable electronic devices includes a first casing made of thermoplastic with additive mixed therein, a decoration layer made of metal, and a second casing made of transparent thermoplastic. The decoration layer is formed on the first casing. The second casing is attached on the first casing and covers the decoration layer.

### BACKGROUND

1. Technical Field

The present disclosure relates to housings of portable electronic devices, and particularly to a plastic housing of portable electronic devices and a method for manufacturing the same.

2. Description of Related Art

Metallic patterns are often formed on plastic housings of portable electronic devices to enhance the external appearances of the portable electronic devices. A typical method for forming the metallic patterns on the plastic housings generally includes forming metal layers on the plastic housings by plating operations (e.g., electroplating, chemical plating, or vacuum plating), then removing unwanted parts of the metal layers by engraving operations (e.g., laser engraving). However, forming the metal layers may require a substantial amount of metal and high cost, and the engraving operations for removing the unwanted parts of the metal layers may also damage the plastic housings. Furthermore, before the metal layers are formed on the plastic housings, the plastic housings often require activating or coarsening operations to ensure the metal layers formed on the plastic housings securely attached to the plastic housings. The activating or coarsening operations further complicate the method.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a schematic view of a housing of portable electronic devices, according to an exemplary embodiment.

FIG. 2 is a cutaway view along the line II-II shown in FIG. 1.

### DETAILED DESCRIPTION

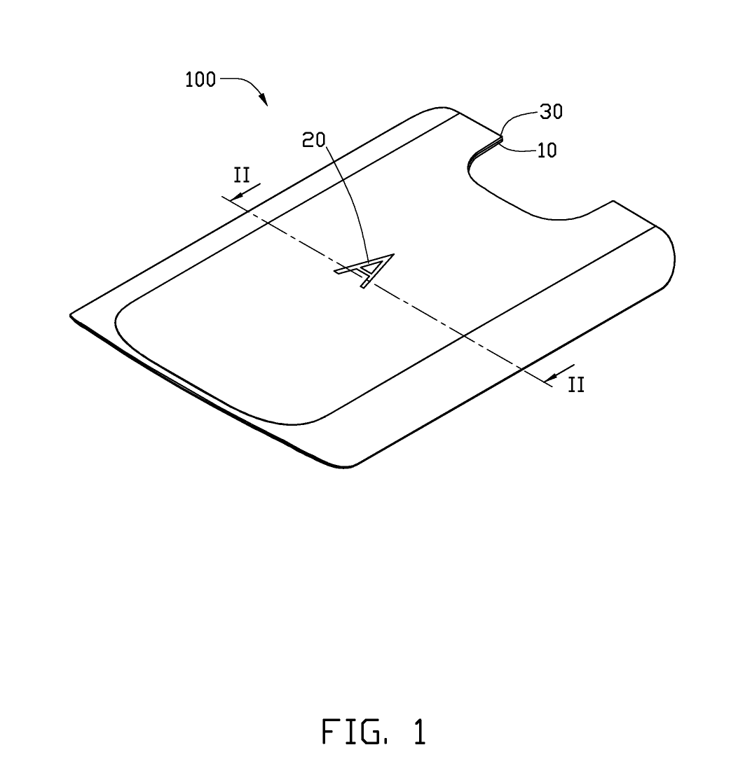

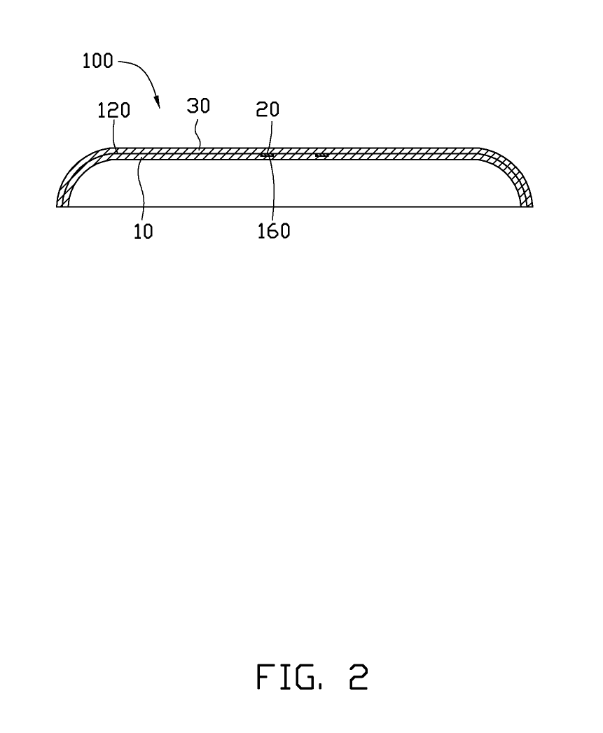

Referring to FIG. 1 and FIG. 2, a housing 100 according to an exemplary embodiment is provided. The housing 100 can be used in portable electronic devices, such as mobile phones, personal digital assistants, and notebook computers. The housing 100 includes a first casing 10, a decoration layer 20 in a predetermined shape, and a second casing 30. Both the first casing 10 and the second casing 30 are made of plastic, and the first casing 10 and the second casing 30 are attached to each other. The second casing 30 is transparent. The decoration layer 20 is made of metal. The decoration layer 20 is formed on the first casing 10 and located between the first casing 10 and the second casing 30. Since the second casing 30 is transparent, the decoration layer 20 can be viewed through the second casing 30.

Both the first casing 10 and the second casing 30 are substantially planar boards. The first casing 10 includes an assembling surface 120, and the assembling surface 120 is partially sunken to form at least one recessed decoration portion 160. The decoration portion 160 has a predetermined shape corresponding to the decoration layer 20, and the decoration layer 20 is formed in the decoration portion 160 to partially cover the first casing 10. The second casing 30 is attached on the assembling surface 120 to cover the decoration layer 20 and parts of the assembling surface 120 that are not covered by the decoration layer 20.

In particular, the first casing 10 is made of thermoplastic with additive mixed therein. The thermoplastic for making the first casing 10 can consist of at least one selected from polyvinyl chloride (PVC), polyethylene terephthalate (PET), acrylonitrile butadiene styrene copolymer (ABS), polycarbonate (PC), polyimide (PI), liquid crystal polymer (LCP), polyether imide (PEI), poly phenylene sulfide (PPS), polystyrene (PS), polypropylene (PP), and glycol modified polyester. The additive includes laser activated substances. The laser activated substances can be powder of insulating metallic oxides, such as spinel powder. The additive can further include powder of fillers, such as powder of silicic acid and/or silicic acid derivatives. The fillers can increase hardness of the first casing 30.

The second casing 30 is made of transparent thermoplastic. The transparent thermoplastic for making the second casing 30 can consist of at least one selected from PVC, PP, PS, ABS, Nylon, PC, PET, polyethylene (PE), polyurethane (PU), and polyfluortetraethylene (PTFE, Teflon). In this embodiment, a thickness of the second casing 30 can be about 0.6 mm-1.0 mm. Due to the appropriate thickness of the second casing 30, when the decoration layer 20 is viewed through the second casing 30, the metallic texture of the decoration layer 20 can be seen, and thus the external appearance of the housing 100 is enhanced. In another embodiment, the thickness of the second casing 30 can be in a range of about 0.6 mm-0.75 mm.

A method for manufacturing the housing 100, according to an exemplary embodiment, includes these steps as follows.

First, the aforementioned materials for making the first casing 10 are provided. The additive is mixed with the thermoplastic for making the first casing 10, and the thermoplastic for making the first casing 10 is melted. In this embodiment, the additive can be mixed with powder of the thermoplastic for making the first casing 10 before the thermoplastic for making the first casing 10 is melted, and can also be mixed with the thermoplastic for making the first casing 10 after the thermoplastic for making the first casing 10 is melted.

The melted thermoplastic for making the first casing 10 with the additive mixed therein is injected into a first mold and then cooled down to form a blank of the first casing 10.

The assembling surface 120 is defined on the blank of the first casing 10, and the assembling surface 120 is engraved such as by laser to form the decoration portion 160. When the laser reaches the engraved part of the blank of the first casing 10, thermoplastic in the engraved part is melted and/or gasified and then removed to form the decoration portion 160, and laser activated substances in the engraved part are activated. The activation decomposes the laser activated substances in the engraved part. The decomposition reaction of the laser activated substances in the engraved part generates metal powder, and the metal powder adheres to the decoration portion 160 and forms a metallic layer that can act as an electrode (see below) on the decoration portion 160. Thus, the first casing 10 is finished.

The decoration layer 20 is formed on the first casing 10 by electroplating or chemical plating. In the first casing 10, only the metallic layer formed on the decoration portion 160 is conductive and can be used as a cathode in the electroplating or chemical plating process. Therefore, the decoration layer 20 can only be formed on the metallic layer and then cover the decoration portion 160. In this way, the decoration layer 20 can be prevented from being mistakenly formed on other parts of the first casing 10 and ensured to be in the same shape as the decoration portion 160.

Finally, the first casing 10 with the decoration layer 20 formed thereon is placed in a second mold. The aforementioned materials for making the second casing 30 are melted and injected into the second mold to cover the decoration layer 20 and parts of the assembling surface 120 that are not covered by the decoration layer 20. Thus, the melted materials for making the second casing 30 are cooled down to form the second casing 30 attached on the assembling surface 120. In this way, the housing 100 is finished.

As detailed above, the decoration layer 20 viewed through the second casing 30 can show metallic texture and enhance the external appearance of the housing 10. Furthermore, because the decoration layer 20 is covered by the second casing 30, the decoration layer 20 can be protected from being stained and worn.

Because the decoration layer 20 can only be formed in the decoration portion 160 and is prevented from being mistakenly formed on other parts of the first casing 10, the method of the present disclosure does not need operations for removing unwanted portions of the decoration layer 20, and metal for making the decoration layer 20 is conserved. Furthermore, the method of the present disclosure does not need typical activating or coarsening operations. Compared with typical methods, the method of the present disclosure is simpler and lower in cost.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A housing of portable electronic devices, comprising:
a first casing made of thermoplastic with additive mixed therein;
a decoration layer formed on the first casing, the decoration layer made of metal; and
a second casing attached on the first casing and covering the decoration layer, the second casing made of transparent thermoplastic.

2. The housing as claimed in claim 1, wherein the first casing includes an assembling surface, the assembling surface having a partially sunken portion forming at least one recessed decoration portion; the decoration layer formed in the decoration portion to partially cover the first casing, and second casing attached on the assembling surface to cover the decoration layer and parts of the assembling surface that are not covered by the decoration layer.

3. The housing as claimed in claim 1, wherein the thermoplastic for making the first casing consists of at least one selected from polyvinyl chloride, polyethylene terephthalate, acrylonitrile butadiene styrene copolymer, polycarbonate, polyimide, liquid crystal polymer, polyether imide, poly phenylene sulfide, polystyrene, polypropylene, and glycol modified polyester.

4. The housing as claimed in claim 3, wherein the additive includes laser activated substances, the laser activated substances being insulating metallic oxides that are decomposed and generate metal when activated by laser.

5. The housing as claimed in claim 1, wherein the transparent thermoplastic for making the second casing consists of at least one selected from polyvinyl chloride, polypropylene, polystyrene, acrylonitrile butadiene styrene copolymer, Nylon, polycarbonate, polyethylene terephthalate, polyethylene, polyurethane, and polyfluortetraethylene.

6. The housing as claimed in claim 1, wherein a thickness of the second casing is about 0.6 mm-1.0 mm.

7. The housing as claimed in claim 6, wherein the thickness of the second casing is about 0.6 mm-0.75 mm.

8. A method for manufacturing a housing of portable electronic devices, comprising:
mixing laser activated substances with thermoplastic, the laser activated substances being insulating metallic oxides that when activated by laser decompose and generate metal;
forming a blank using the thermoplastic with the laser activated substances mixed therein;
engraving the blank using laser to form a decoration portion on the blank and activate the laser activated substances in the engraved part of the blank, such that the laser activated substances in the engraved part of the blank decompose and generate metal to form a metallic layer on the decoration portion, thereby forming a first casing;
forming a decoration layer made of metal on the metallic layer by electroplating or chemical plating; and
forming a transparent second casing on the first casing to cover the decoration layer.

9. The method as claimed in claim 8, wherein the thermoplastic for making the first casing consists of at least one selected from polyvinyl chloride, polyethylene terephthalate, acrylonitrile butadiene styrene copolymer, polycarbonate, polyimide, liquid crystal polymer, polyether imide, poly phenylene sulfide, polystyrene, polypropylene, and glycol modified polyester.

10. The method as claimed in claim 8, wherein the second casing is made of transparent thermoplastic.

11. The method as claimed in claim 10, wherein the transparent thermoplastic consists of at least one selected from polyvinyl chloride, polypropylene, polystyrene, acrylonitrile butadiene styrene copolymer, Nylon, polycarbonate, polyethylene terephthalate, polyethylene, polyurethane, and polyfluortetraethylene.

12. The method as claimed in claim 10, wherein the second casing is formed on the first casing by means of injection molding.
